(19) United States
(12) Patent Application Publication
(10) Pub. No.: US 2016/0210454 A1
(43) Pub. Date: Jul. 21, 2016

(54) SYSTEM, APPARATUS, AND METHOD FOR ACCESS CONTROL

(71) Applicant: Pu-Yao Chou, Taipei (TW)

(72) Inventor: Pu-Yao Chou, Taipei (TW)

(21) Appl. No.: 14/960,827

(22) Filed: Dec. 7, 2015

Related U.S. Application Data
(60) Provisional application No. 62/104,273, filed on Jan. 16, 2015.

(51) Int. Cl. G06F 21/40; G06F 21/32

(52) U.S. Cl. CPC G06F 21/40; G06F 21/32

(57) ABSTRACT

An aspect of the disclosure provides an access control system configured to verify a user device within a region, based on wireless communication and a confirmation code which may include one or more static key(s) and/or time-varying key(s), and to verify a user of the user device within the region, based on biometric recognition after the user device is verified. In this way, at least one resource is allowed to be accessed when at least the verification of the user is passed. Further, accessing a resource may be consuming, entering, or using the resource. A variety of practical applications may then be performed for the user, due to the allowance of accessing the resource.

### CROSS-REFERENCES TO RELATED APPLICATION

This non-provisional application claims priority under 35 U.S.C. §119(a) on U.S. provisional application No. 62/104,273 filed on Jan. 16, 2015, the entire contents of which are hereby incorporated by reference.

### BACKGROUND

1. Technical Field

The present invention relates generally to access control, and, more particularly, to system, apparatus, and method for access control.

2. Related Art

In physical security and information security, access control is to selectively restrict access of users to a place or resource. In an access control system, biometrics is often applied, such as fingerprint recognition, face recognition, and so on, which refers to metrics related to human characteristics, in security systems as a manner of identification and access control. For meeting a higher security standard, an access control system usually requires a user to provide credential information before performing biometric recognition, such as putting a card onto a reader of the access control system, or entering personal identification number. This would cause inconvenience for the users.

For the foregoing reasons, there is a need for systems and methods for effectively providing access control and bringing better user experience.

### SUMMARY

Embodiments of the disclosure provide system, apparatus, and method for access control for effectively providing access control and bringing better user experience.

A first aspect of the disclosure provides an access control system configured to verify a user device within an access-controlled region, based on wireless communication and a confirmation code which may include one or more static key(s) and/or time-varying key(s), and to verify a user of the user device within the access-controlled region, based on biometric recognition after the user device is verified.

A second aspect of the disclosure provides an access control system includes a first access control unit and a second access control unit. The first access control unit is configured to communicate with a user device within an access-controlled region, for providing the confirmation code for verification of the user device. The second access control unit is configured to communicate with the user device to verify whether the user device is authentic, based on the confirmation code and identification of the user device. The second access control unit is also configured to communicate with the first access control unit to indicate whether the user device is authentic. When it is indicated that the user device is authentic, the first access control unit verifies a user of the user device within the access-controlled region, based on biometric recognition.

A third aspect of the disclosure provides an access control method including: verifying a user device within an access-controlled region, based on communication link and a confirmation code which may include one or more static key(s) and/or time-varying key(s); and verifying a user of the user device within the access-controlled region, based on biometric recognition after the user device is verified.

A fourth aspect of the disclosure provides an access control method including: communicating, by a first access control unit, with a user device within an access-controlled region, for providing the confirmation code for verification of the user device; communicating between a second access control unit and the user device to verify whether the user device is authentic, based on the confirmation code and identification of the user device; communicating, by the second access control unit, with the first access control unit to indicate whether the user device is authentic; when it is indicated that the user device is authentic, verifying, by the first access control unit, a user of the user device within the access-controlled region, based on biometric recognition.

In each of the above aspects of the disclosure, when the verifications of the user device and the user are passed, accessing a resource is allowed, wherein accessing a resource may be consuming, entering, or using the resource. A variety of practical applications may then be performed for the user, due to the allowance of accessing the resource.

In some embodiments, the confirmation code includes a plurality of keys which are varied with time when it is provided.

In one embodiment, the confirmation code is broadcast by way of a first communication link, such as Wi-Fi, Bluetooth, Bluetooth low energy (BLE), ZigBee, and near field communication.

In some embodiments, the user device and the second access control unit communicate via a second communication link, such as a mobile network (e.g., 3G, 4G, and so on) and/or the Internet.

In some embodiments, the first and the second access control units communicate via a third communication link, such as, a wired network, a mobile network (e.g., 3G, 4G, and so on), and/or the Internet.

In some embodiments, the user device, the first access control unit, and the second access control unit communicate with each other within a wireless local area network or an intranet.

For better understanding of the above and other aspects of the invention, a plurality of embodiments or examples will be taken with accompanying drawings to provide detailed description as follows.

### BRIEF DESCRIPTION OF THE DRAWINGS

These and other features, aspects, and advantages of the present invention will become better understood with regard to the following description and accompanying drawings where:

FIG. 1 illustrates an access control system according to a first embodiment.

FIG. 2 illustrates an access control system according to a second embodiment.

FIG. 3 illustrates an example of the access control system according to the second embodiment.

FIG. 4 illustrates an example of the first access control unit in a block diagram.

FIG. 5 illustrates another example of the first access control unit in a block diagram.

FIG. 6 illustrates another example of the access control system in block diagram form.

FIG. 7 illustrates an access control sub-system according to an embodiment in block diagram form.

FIG. 8 illustrates an example of a computer node in block diagram form.

FIG. 9 illustrates an access control method according to an embodiment in flowchart form.

FIG. 10 illustrates an embodiment of step S110 in flowchart form.

### DETAILED DESCRIPTION

The present invention will be described with reference to illustrative embodiments. For this reason, numerous modifications can be made to these embodiments and the results will still come within the scope of the disclosure. No limitations with respect to the specific embodiments described herein are intended or should be inferred.

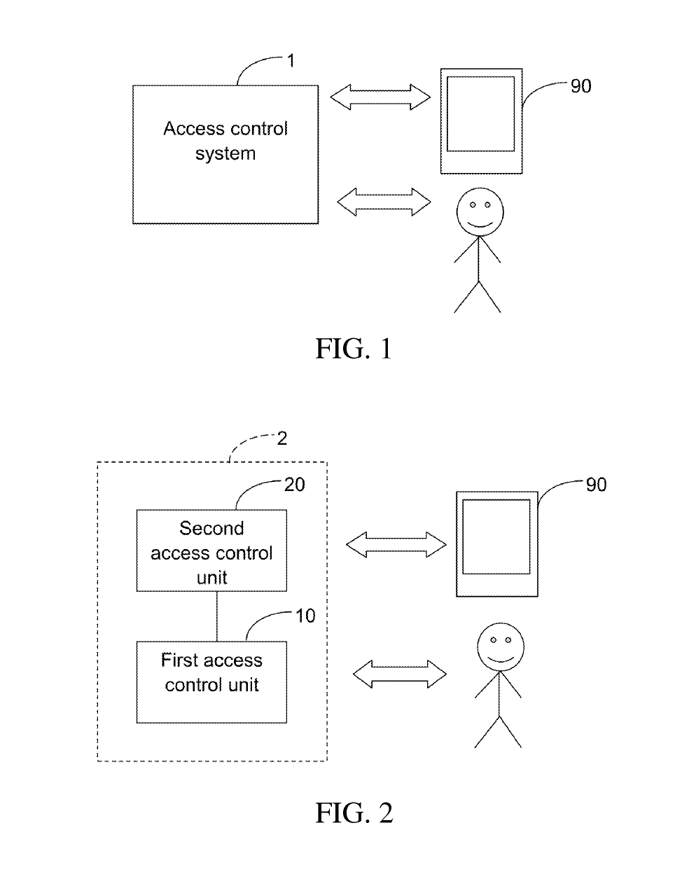

Referring to FIG. 1, an access control system 1 is illustrated according to a first embodiment. In FIG. 1, an access control system 1 is configured to verify a user device 90 within an access-controlled region, based on wireless communication and a confirmation code which may include one or more static key(s) and/or time-varying key(s), and to verify a user of the user device within the access-controlled region, based on biometric recognition after the user device is verified.

The user device 90 may be a portable electronic device, e.g., a communication device (such as a mobile device: smart phone, a tablet computer), a wearable device, a multimedia player, or a dedicated device (e.g., an electric key).

In some embodiments, the confirmation code includes one or more static key(s) and/or time-varying key(s). In one example, the confirmation code is static data. In some embodiments, the confirmation code is a plurality of keys which are varied with time when provided by the access control system 1. In one example, the keys are varied in value (e.g., any data type such as numbers, characters, binary, hexadecimal, may be used, but not limited thereto) for every time period. In another example, the keys are varied in value in any time sequence. No matter how the keys vary, the user device may be configured to receive a plurality of keys within one or more time intervals. In yet another example, the time-varying key may be generated based on a function (such as a hash function) with respect to time or with respect to one or more parameters varied with time.

The biometric recognition may be based on at least one biometric identifier, which can be physiological and/or behavioral characteristics. Physiological characteristics are related to the shape of the body. Examples include, but are not limited to fingerprint, palm veins, face recognition, palm print, hand geometry, iris recognition, retina. Behavioral characteristics are related to the pattern of behavior of a person, including but not limited to typing rhythm, head, hand or walking movement, gait, and voice. In an example, the biometric recognition is based on face recognition. In another example, the biometric recognition is based on face recognition and a specific act or a voice password by the user.

When the verification of the user device 90 and the user are passed, accessing a resource is allowed, wherein accessing a resource may be consuming, entering, or using the resource. A variety of practical applications may then be performed for the user, due to the allowance of accessing the resource.

In one example, the access control system 1 may be used to control an electronic gate or door. The gate or door will be opened automatically when an authorized user along with the user device identification of which is registered is approaching the gate, after the verification of the user device and the user.

In another example, the access control system 1 may be applied in an intelligent home system to identify an authorized user along with the user device. When the user is identified, various decisions and services can be performed by the intelligent home system in addition to entry control. For instance, as the user verified by the access control system 1 enters the door of the house, the light system or household appliances are switched on automatically according to the user's profile. For instance, as the user is leaving the house, a reminder for the user can be provided.

In another example, the access control system 1 may be utilized to provide personalized services in a public place, working place, or recreation place for different purposes. For instance, in a hotel with a user service system, when a user verified by the access control system 1 comes in the gate of the hotel, the user service system provides the checking-in service for the user to check in and/or other services according to the user's requirement or profile. The service may be performed at a physical dedicated system or may be performed in the user device through an application program installed in the user device or through the browser.

In another example, the access control system 1 may be utilized in a vehicle for different purposes. For instance, when a user verified by the access control system 1 approaches the vehicle, the vehicle may open the door of the vehicle and/or provide services (e.g., adjusting the seat for the user, playing music, or providing weather information or reminders), for the user according to the user's requirement or profile.

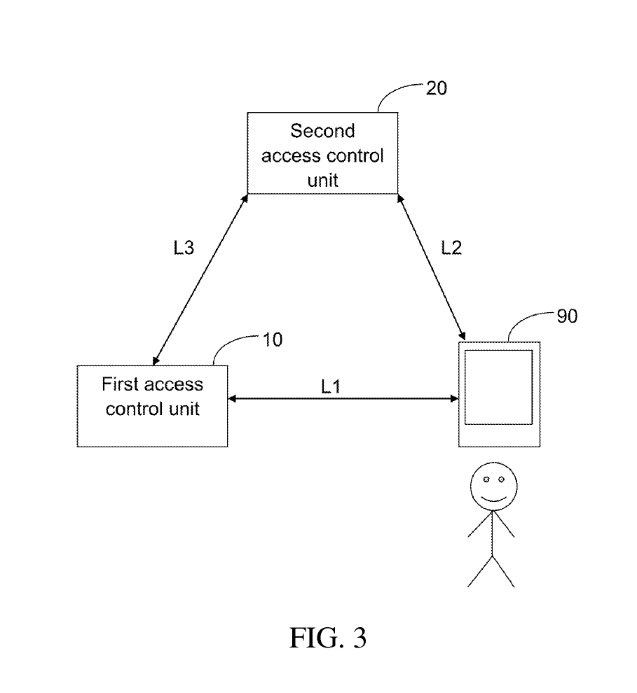

FIGS. 2 and 3 illustrate an access control system 2 according to a second embodiment. As shown in FIG. 2, the access control system 2 includes a first access control unit 10 and a second access control unit 20. The first access control unit 10 is configured to communicate with a user device 90 within an access-controlled region, for providing the confirmation code for verification of the user device 90. The second access control unit 20 is configured to communicate with the user device 90 to verify whether the user device 90 is authentic, based on the confirmation code and identification of the user device 90. The second access control unit 20 is also configured to communicate with the first access control unit 10 to indicate whether the user device 90 is authentic. When it is indicated that the user device 90 is authentic, the first access control unit 10 verifies a user of the user device 90 within the access-controlled region, based on biometric recognition.

Each of the examples or combination thereof for the first embodiment can also be applied to the second or other embodiment.

In one example, the confirmation code is broadcast by way of a first communication link L1, such as one of Wi-Fi, Bluetooth, Bluetooth low energy (BLE), ZigBee, and near field communication.

In some examples, the user device 90 and the second access control unit 20 communicate via a second communication link L2, such as a mobile network (e.g., 3G, 4G, and so on) and/or the Internet; but the invention is limited thereto.

In some examples, the first access control unit 10 and the second access control unit 20 communicate via a third communication link L3, such as, a wired network, a mobile network (e.g., 3G, 4G, and so on), and/or the Internet; but the invention is limited thereto.

In some embodiments, the user device, the first access control unit, and the second access control unit communicate with each other within a wireless local area network or an intranet.

In following examples of the second embodiment, location-based communication, such as a short distance communication protocol, and biometric recognition are applied.

In a practical example, the first access control unit 10 is equipped so as to control accessing to a resource, such as a gate, other application, or service, as exemplified in the disclosure above. When a user approaches the first access control unit 10 (which may be electronically coupled to an electronic gate), the first access control unit 10 communicates with a user device 90 within an access-controlled region by way of a communication protocol such as Bluetooth, BLE, or NFC, for providing the confirmation code for verification of the user device 90. As required by the communication protocol, a communication process, such as pairing between the first access control unit 10 and the user device 90 is to be performed, wherein a private key and a public key may be required for instance. After the communication process, the first access control unit 10 and the user device 90 can be linked wirelessly via the first communication link L1 (e.g., Bluetooth, BLE, or NFC). In addition, the first access control unit 10 then broadcasts the confirmation code. The user device 90 is configured to receive the confirmation code from the first access control unit 10 and then sends credential information including at least the received confirmation code along with an identification of the user device 90 to the second access control unit 20. The second access control unit 20, such as a server in a cloud server system, is configured to communicate with the user device 90 to verify whether the user device 90 is authentic, based on the confirmation code and identification of the user device 90, such as the credential information sent from the user device 90. For example, the second access control unit 20 may perform the verification by comparing the credential information with a database storing the identification of registered user devices and/or by performing confirmation with the first access control unit 10 (such as handshaking, sending requests). The second access control unit 20 is also configured to communicate with the first access control unit 10 to indicate whether the user device 90 is authentic, such as sending an indication signal to the first access control unit 10. When it is indicated that the user device 90 is authentic, the first access control unit 10 verifies a user of the user device 90 within the access-controlled region, based on biometric recognition. For instance, face recognition is performed with the user.

In another example, the user device 90, the first access control unit 10, and the second access control unit 20 communicate with each other within a communication network, such as a local area network, or intranet. For example, the second access control unit 20 can be a wireless network device, such as a server, router, or IP sharing device, and the first access control unit 20 and the user device 90 are linked to the second access control unit 20. When a user approaches the first access control unit 10, the first access control unit 10 communicates with a user device 90 within an access-controlled region by way of a communication protocol such as Wi-Fi, for providing the confirmation code (e.g., as exemplified in the above) for verification of the user device 90. As required by the communication protocol, authentication between the first access control unit 10 and the user device 90 is performed, wherein a private key and a public key are required for instance. After the authentication, the first access control unit 10 and the user device 90 are linked wirelessly via the communication protocol such as Wi-Fi. In addition, the first access control unit 10 then broadcasts the confirmation code. The user device 90 is configured to receive the confirmation code from the first access control unit 10 and then sends credential information including at least the received confirmation code along with an identification of the user device 90 to the second access control unit 20. The second access control unit 20 is configured to communicate with the user device 90 to verify whether the user device 90 is authentic, based on the confirmation code and identification of the user device 90, such as the credential information sent from the user device 90. For example, the second access control unit 20 may perform the verification by comparing the credential information with a database storing the identification of registered user devices and/or by performing confirmation with the first access control unit 10 (such as handshaking, sending requests). The second access control unit 20 is also configured to communicate with the first access control unit 10 to indicate whether the user device 90 is authentic. When it is indicated that the user device 90 is authentic, the first access control unit 10 verifies a user of the user device 90 within the access-controlled region, based on biometric recognition. For instance, face recognition is performed with the user.

In the above examples, it is required to confirm whether the user device 90 is in the vicinity of the house. When the user device 90 receives the confirmation code broadcast via the communication protocol, such as Wi-Fi, Bluetooth, BLE, or NFC, which exchange data over a short distance, by the first access control unit 10, it is indicated that the user device 90 approaching the house. Afterwards, it is required to confirm whether the user device 90 approaching the house, i.e., in the vicinity of the house, is an authenticated user device. It is supposed that an authenticated user device can receive and recognize the broadcast confirmation code via the communication protocol. In this regard, where the user device 90 communicates with the second access control unit 20 (such as a server connected in the Internet), it is to confirm whether the user device 90 approaching the house is an authenticated user device, and whether the confirmation code that the user device 90 has received is authentic. If it is confirmed that the user device 90 approaching the house is an authenticated user device, and that the confirmation code that the user device 90 has received are authentic, the first access control device 10 can proceed to perform biometric recognition.

In some embodiments for access control with respect to guest users, location-based communication, such as a short distance communication protocol, and biometric recognition, as exemplified above, can also be applied. In addition, a guest user for requesting accessing to a resource may need to pre-register, or register on demand, in the first access control unit 10 or the second access control unit 20, but the invention is not limited thereto.

In an example, a guest user (e.g., a friend of the household) with one's user device is going to the house for entry. The user device of the guest user communicates with the second access control unit 20 (e.g., via a network connection) to perform registration and then is granted an access right for a short period of time, for example 10 or 20 minutes. When the guest user with the user device approaches the first access control unit 10, the verification for the user device 90 as in one of the above examples may be performed to confirm that the user device of the guest user approaches the house is an authenticated device and has received a confirmation code (e.g., as exemplified above, which may be the same or different from that for the household) broadcast within a short distance (which is regarded as a region of the house). After the verification of the user device of the guest user is passed, the first access control unit 10 can then perform verification of the guest user with the user device, based on biometric recognition, e.g., as any one exemplified above. The entrance can be opened (or a resource can be accessed) after the verification of the user, for instance.

In another example, a guest user with one's user device approaches the house for entry. The user device of the guest user communicates with the first access control unit 10 (e.g., via a communication protocol) and obtain a confirmation code (e.g., as exemplified above, which may be the same or different from that for the household). Then, the user device of the guest user requests at least one temporary right from the household, e.g., by the first access control unit 10, or any other approach, such as a messaging program, but not limited thereto. After the guest user is granted the requested right, the verification for the user device 90 as in one of the above examples may be performed to confirm that the user device of the guest user approaches the house is an authenticated device and has received the confirmation code broadcast within a short distance (which is regarded as a region of the house). After the verification of the user device of the guest user is passed, the first access control unit 10 can then perform verification of the guest user with the user device, based on biometric recognition, e.g., as any one exemplified above. The entrance can be opened (or a resource can be accessed) after the verification of the user, for instance.

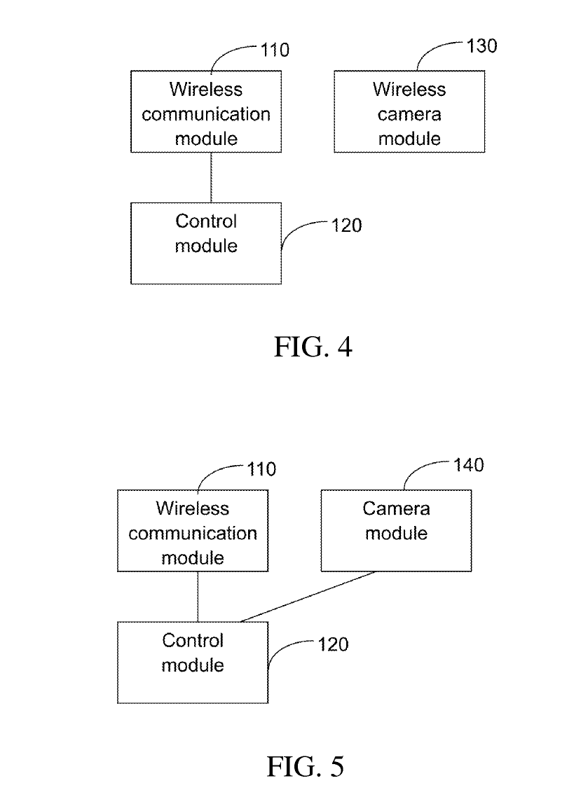

FIG. 4 illustrates an example of the first access control unit in a block diagram. In FIG. 4, the first access control unit 10 includes a wireless communication module 110, a control module 120, and a wireless camera module 130. The wireless communication module 110 is configured to communicate with the user device 90. The control module 120 controls the wireless communication module 110 and wireless camera module 130 to perform the verification as stated above, wherein the wireless camera module 130 communicates with the control module 120 wirelessly. For instance, the first access control unit 10 in FIG. 4 may be implemented in a way that the functionality of the wireless communication module 110 and the control module 120 is performed by a computing system, such as a desktop, notebook, or tablet computer, for (or may be outside or inside) a room, house, building, or place, and the wireless camera module 130 is disposed near an entrance to the room, house, building, or place, and communicates with the computing system wirelessly.

FIG. 5 illustrates another example of the first access control unit in a block diagram. In FIG. 5, the first access control unit 10 includes a camera module 140 instead of the wireless camera module 130, and the control module 120 is electronically coupled to the control module 120. For instance, the first access control unit 10 in FIG. 5 may be implemented in a way that the functionality of the wireless communication module 110 and the control module 120 is performed by a computing system, such as a desktop, notebook, or tablet computer house, for (outside or inside) a room, house, building, or place, and the camera module 140 is disposed near an entrance to the room, house, building, or place, and communicates with the computing system in a wired manner. The wireless communication module 110 and/or the control module 120 may be implemented by a dedicated circuit, an embedded system, or gate array, DSP, PLA, ASIC or other processing or logic element(s).

In the examples of FIG. 4 or 5, the first access control unit 10 may be implemented as a dedicated access control apparatus for accessing to a resource, such as accessing to an entrance to a room, house, building, or place. The camera module (i.e., 130 or 140) may be used for biometric recognition, such as iris or face recognition. In further examples, other sensor(s) or devices(s) for biometric recognition or access control can also be included in the first access control unit, whether the first access control unit is dedicated implementation or not.

In another embodiment, an access control method is provided for an access control system. The method includes: verifying a user device within an access-controlled region, based on wireless communication and a confirmation code (e.g., as exemplified above); and verifying a user of the user device within the access-controlled region, based on biometric recognition after the user device is verified.

In another embodiment, an access control method is provided for an access control system. The method includes: communicating, by a first access control unit, with a user device within an access-controlled region, for providing the confirmation code for verification of the user device; communicating between a second access control unit and the user device to verify whether the user device is authentic, based on the confirmation code and identification of the user device; communicating, by the second access control unit, with the first access control unit to indicate whether the user device is authentic; when it is indicated that the user device is authentic, verifying, by the first access control unit, a user of the user device within the access-controlled region, based on biometric recognition.

In another embodiment, an access control method is provided for the first access control unit as exemplified above.

In another embodiment, an access control method is provided for the second access control unit as exemplified above.

In each of the above embodiments, when the verifications of the user device and the user are passed, accessing a resource is allowed, wherein accessing a resource may be consuming, entering, or using the resource. A variety of practical applications, such as the ones stated above, but not limited thereto, may then be performed for the user, due to the allowance of accessing the resource.

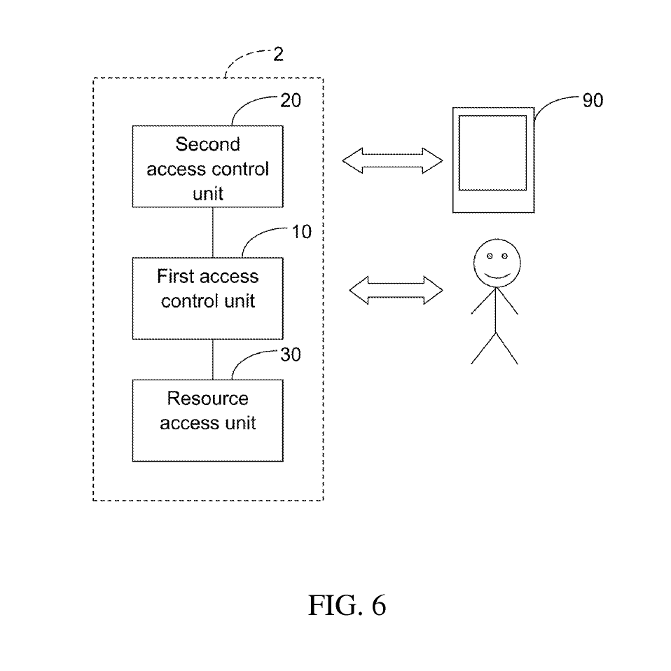

For example, in an embodiment as shown in FIG. 6, the access control system 2 can further include a resource access unit 30, configured to allow at least one resource to be accessed when at least the verification of the user is passed by way of the first access control unit. The resource can be exemplified as in the examples and embodiments above; but the invention is not limited thereto. The resource access unit 30, for example, may be implemented as at least one portion of a physical access control structure, which can be a door or a gate such as an access gate, equipped with a locking device and/or door opening mechanism. In addition, the resource access unit 30, for example, may be implemented as at least one portion of a vehicle, which can be a door lock system and/or door opening mechanism of the vehicle. The resource access unit 30 may also be a computing system which can be accessed or used by the user when the verifications of the user device and the user are passed.

In an example, the resource access unit 30 comprises an electronic locking device coupled to the first control access unit 10; the at least one resource includes an unlocking of the electronic locking device; the electronic locking device is enabled to be unlocked when at least the verification of the user is passed by way of the first access control unit 10. The electronic locking device may be equipped in a gate or door for entrance to a building or equipped in a vehicle for access to the vehicle, and so on. In an embodiment, the at least one resource may further include opening of a gate or door on which the electronic locking device is equipped, for example; and the gate or door is opened at least after the verification of the user is passed by way of the first access control unit 10.

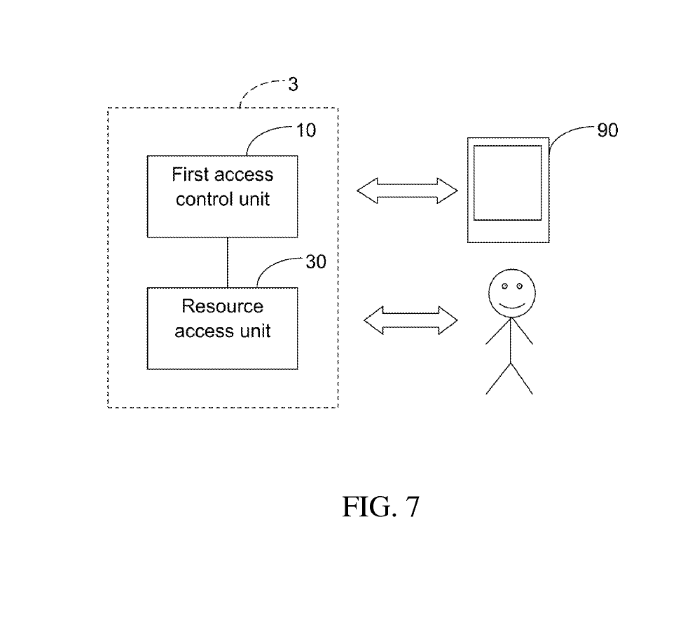

In a yet further aspect, an access control sub-system 3 is provided, which comprises: a first access control unit 10 and a resource access unit 30, as illustrated in FIG. 7. The first access control unit 10 is configured to communicate with a user device 90 within a region wirelessly, for providing a confirmation code based on at least one static key and/or time-varying key for verification of the user device 90, wherein the first access control unit 10 verifies a user of the user device 90 within the region, based on biometric recognition when the first access control unit 10 is informed that the user device 90 is authentic by a second access control unit (e.g., as exemplified in any of the above embodiments). The resource access unit 30, as discussed above, is coupled to the first access control unit 10, and is configured to allow at least one resource to be accessed when at least the verification of the user is passed by way of the first access control unit 10. For example, the access control sub-system 3 can be employed for access control (or entrance control) in a building, or in a vehicle, such as a car, motorcycle, and so on for access to the vehicle; but the invention is not limited thereto, and the access control sub-system 3 can be employed for access control to any resource in any other applications.

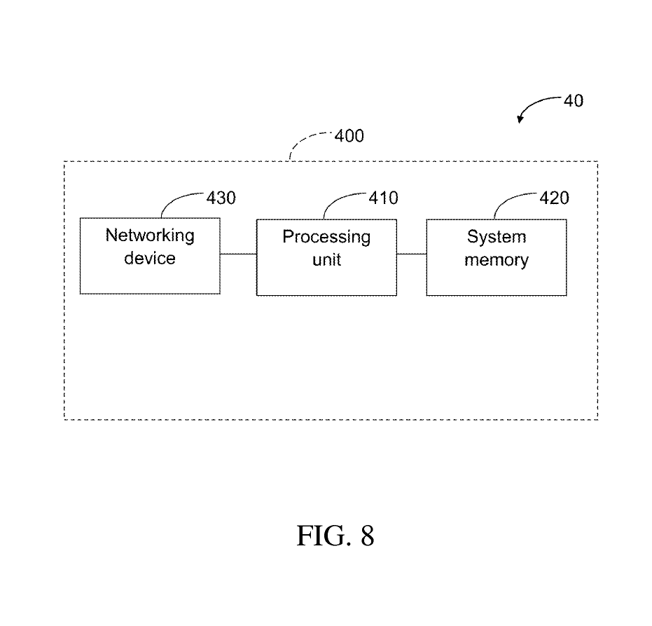

In addition, the second access control unit 20 can be implemented as at least one or more computing nodes, in a network or in a cloud computing environment, for providing at least services of verification of user devices and can communicate with one or more first access control units and/or access control sub-systems. Referring now to FIG. 8, a schematic of an example of a computing node 40 is shown. The computing node 40 is only one example of a suitable computing node and is not intended to suggest any limitation as to the scope of use or functionality of embodiments of the invention described herein. Regardless, the computing node 40 is capable of being implemented and/or performing any of the functionality set forth hereinabove for the second access control unit 20.

In the computing node 40, there is a computer system 400 which may include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 400 may be described in the general context of computer system-executable instructions, such as program modules, being executed by a computer system. The computer system 400 may be practiced in distributed cloud computing environments where tasks are performed by remote processing devices that are linked via one or more communications network (such as the second communication link L2 and communication link L3). In a distributed cloud computing environment, program modules may be located in both local and remote computer system storage media including memory storage devices.

As shown in FIG. 8, the computer system 400 in the computing node 40 is shown in the form of a general-purpose computing device. The components of the computer system 400 may include, but are not limited to, one or more processors or processing units 410, a system memory 420, and a networking device 430; and one or more buses is provided to couple various system components including the system memory 420 to the processing unit 410, the system memory 420, and the networking device 430. In addition, the first access control unit can also be implemented based on the structure as illustrated in FIG. 8, but the invention is not limited thereto.

The system memory 420 can include computer system readable media in the form of volatile memory, such as random access memory (RAM) and/or cache memory. The computer system 400 may further include other removable/non-removable, volatile/non-volatile computer system storage media. As will be further depicted and described below, the system memory 420 may include at least one program product having a set (e.g., at least one) of program modules that are configured to carry out the functions of embodiments according to the invention.

The networking device 430 can be configured by the processing unit 410 to communicate with another computer node, such as the user device 90 and/or the first access control unit 10. For example, the computing node 40 can be configured as a wireless network device, such as a server, router, or IP sharing device, and so on.

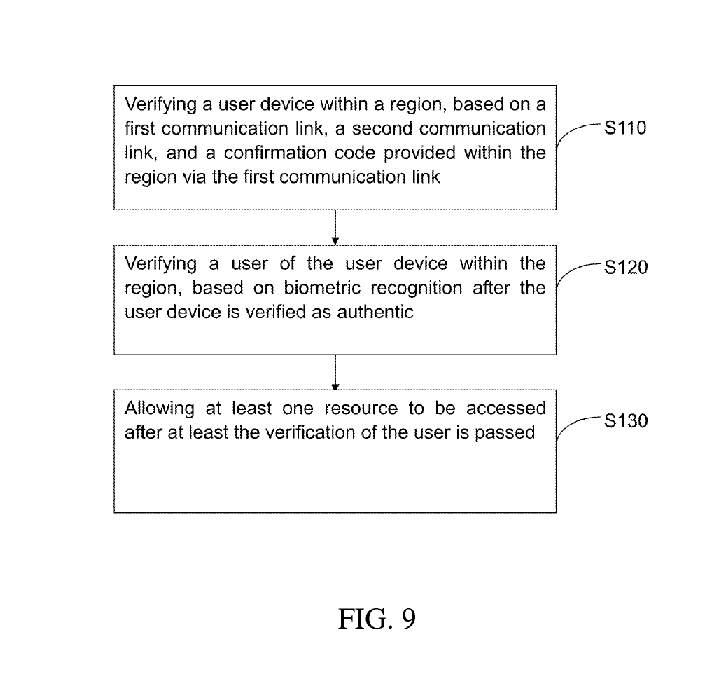

In a further aspect, an access control method is provided as illustrated in FIG. 9. As shown in FIG. 9, the access control method comprises the following steps. In step S110, a user device within a region is verified based on a first communication link, a second communication link, and a confirmation code provided within the region via the first communication link. In step S120, a user of the user device within the region is verified based on biometric recognition after the user device is verified as authentic. In step S130, at least one resource is allowed to be accessed after at least the verification of the user is passed by way of step S120.

In an embodiment of the access control method, the confirmation code includes at least one key that is varied with time.

In another embodiment of the access control method, the confirmation code further includes at least one key that is static.

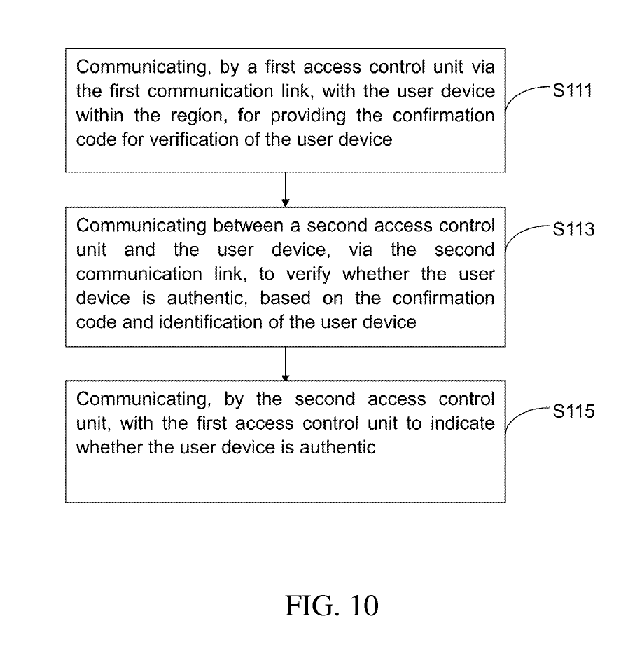

In an embodiment, as shown in FIG. 10, step S110 may include the following. In step S111, communicating, by a first access control unit via the first communication link, with the user device within the region, is performed for providing the confirmation code for verification of the user device. In step S113, communicating between a second access control unit and the user device, via the second communication link, is performed to verify whether the user device is authentic, based on the confirmation code and identification of the user device. In step S115, communicating, by the second access control unit, with the first access control unit is performed to indicate whether the user device is authentic.

In another embodiment of the access control method, the at least one resource includes an unlocking of an electronic locking device; the electronic locking device is enabled to be unlocked when at least the verification of the user is passed by way of step S120.

In addition, the access control method as illustrated in FIG. 9 can be implemented by an access control system according to any of the embodiments as illustrated above.

In a further embodiment of the access control system (or the access control sub-system), the first communication link and the second communication link may be the same kind of links. In another embodiment, the first and/or second communication link may be provided by a star or mesh network (such as one based on BLE or Zigbee), and the region within which a user device can obtain a confirmation code, as exemplified according to any one of the above embodiments, from the access control system (or the access control sub-system) corresponds to the star or mesh network. In yet another embodiment, the second access control unit may be equipped locally and combined with the first access control unit.

Moreover, all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

It will be apparent to those skilled in the art that various modifications and variations can be made to the present disclosure without departing from the spirit and scope of the disclosure. Thus it is intended that the present disclosure cover the modifications and variations of this disclosure provided they come within the scope of the appended claims and their equivalents.

What is claimed is:

1. An access control system, comprising:
a first access control unit, for communicating with a user device within a region wirelessly, and providing a confirmation code for verification of the user device; and
a second access control unit, for communicating with the user device to verify whether the user device is authentic, based on the confirmation code and identification of the user device, and for informing the first access control unit whether the user device is authentic after verification of the user device by the second access control unit;
wherein the first access control unit verifies a user of the user device within the region, based on biometric recognition when the first access control unit is informed that the user device is authentic by the second access control unit.

2. The access control system according to claim 1, wherein the first access control unit generates the confirmation code including at least one key that is varied with time.

3. The access control system according to claim 2, wherein the first access control unit generates the confirmation code further including at least one key that is static.

4. The access control system according to claim 1, wherein the second access control unit is configured to communicate with the user device via a second communication link, the second communication link is based on at least one of a mobile network and an IP-based network; and the first access control unit and the second access control unit are configured to communicate via a third communication link, the third communication link is based on at least one of a wired network, a mobile network, and an IP-based network.

5. The access control system according to claim 1, wherein the user device, the first access control unit, and the second access control unit are configured to communicate with each other within a wireless local area network or an intranet.

6. The access control system according to claim 1, further comprising:
a resource access unit, for allowing at least one resource to be accessed when at least the verification of the user is passed by way of the first access control unit.

7. The access control system according to claim 6, wherein the resource access unit comprises an electronic locking device coupled to the first control access unit; the at least one resource includes an unlocking of the electronic locking device; the electronic locking device is enabled to be unlocked when at least the verification of the user is passed by way of the first access control unit.

8. An access control method, comprising:
(a) verifying a user device within a region, based on a first communication link, a second communication link, and a confirmation code provided within the region via the first communication link;
(b) verifying a user of the user device within the region, based on biometric recognition after the user device is verified as authentic; and
(c) allowing at least one resource to be accessed after at least the verification of the user is passed by way of the step (b).

9. The access control method according to claim 8, wherein the confirmation code includes at least one key that is varied with time.

10. The access control method according to claim 9, wherein the confirmation code further includes at least one key that is static.

11. The access control method according to claim 8, wherein the step (a) comprises:
communicating, by a first access control unit via the first communication link, with the user device within the region, for providing the confirmation code for verification of the user device;
communicating between a second access control unit and the user device, via the second communication link, to verify whether the user device is authentic, based on the confirmation code and identification of the user device; and
communicating, by the second access control unit, with the first access control unit to indicate whether the user device is authentic.

12. The access control method according to claim 11, wherein the user device and the second access control unit communicate via the second communication link which is based on at least one of a mobile network and an IP-based network; and the first and the second access control units communicate via a third communication link which is based on at least one of a wired network, a mobile network, and an IP-based network.

13. The access control method according to claim 11, wherein the user device, the first access control unit, and the second access control unit communicate with each other within a wireless local area network or an intranet.

14. The access control method according to claim 8, wherein the at least one resource includes an unlocking of an electronic locking device; the electronic locking device is enabled to be unlocked when at least the verification of the user is passed by way of the step (b).

15. An access control sub-system, comprising:
a first access control unit, for providing a confirmation code to a user device within a region wirelessly, wherein the first access control unit verifies a user of the user device within the region, based on biometric recognition when the first access control unit is informed that the user device is authentic by a second access control unit; and
a resource access unit, coupled to the first access control unit, wherein the resource access unit allows at least one resource to be accessed when at least the verification of the user is passed by way of the first access control unit.

16. The access control sub-system according to claim 15, wherein the first access control unit generates the confirmation code including at least one key that is varied with time.

17. The access control sub-system according to claim 16, wherein the first access control unit generates the confirmation code further including at least one key that is static.

18. The access control sub-system according to claim 15, wherein the first access control unit comprises:
a communication module;
a camera module;
a control module, coupled to the communication module and the camera module, and configured to provide the confirmation code to the user device wirelessly via the communication module, and to communicate with the second control access unit via the communication module, and to perform biometric recognition using the camera module.

19. The access control sub-system according to claim 15, wherein the resource access unit comprises an electronic locking device coupled to the first control access unit; the at least one resource includes an unlocking of the electronic locking device; the electronic locking device is enabled to be unlocking when at least the verification of the user is passed by way of the first access control unit.
